(19) United States
(12) Patent Application Publication
(10) Pub. No.: US 2012/0118631 A1
(43) Pub. Date: May 17, 2012

(54) Device for fixating cables with pull relief

(76) Inventor: Michael Richter, Schalksmuehle (DE)

(21) Appl. No.: 13/200,157

(22) Filed: Sep. 19, 2011

(30) Foreign Application Priority Data
Oct. 4, 2010 (DE) 102010047239.5-55

(51) Int. Cl. H02G 15/02

(52) U.S. Cl. 174/77 R; 174/82

(57) ABSTRACT

A device for fixating cables with pull relief, including a sleeve component including an outer thread in a first axial portion and a second axial portion that is formed by crush lamellas which are pressed against an outer circumferential surface of a cable that is being fixated. The crush lamellas are pressed against the outer circumferential surface of the cable by a cap nut that is threaded onto the outer thread and provided with a cable pass through opening. The sleeve component is provided with an insert on an inner circumference of its second axial portion that is formed by the crush lamellas, wherein the insert reduces the inner diameter of the sleeve component.

### RELATED APPLICATIONS

This application claims priority from and incorporates by reference German patent application DE 10 2010 047 239.5-55 filed on Oct. 4, 2010.

### FIELD OF THE INVENTION

The invention relates to a device for fixating cables with pull relief, including a sleeve component which includes an outer circumferential thread in a first axial portion and whose second axial portion is formed by crush lamellas which are pressed against an outer circumferential surface of the cable to be fixated through a cap nut that is being threaded onto the thread and that includes a cable pass through opening.

### BACKGROUND OF THE INVENTION

These devices are often threaded sleeves arranged at junction boxes for electrical cables, wherein crush lamellas of the threaded sleeves are pressed against an outer surface of a cable through a cap nut, wherein the cable shall be inserted through the cap nut and the sleeve into the junction box. Thus, the cable is fixated at the junction box with pull relief. These devices that are known in the art can also be found in particular at junction boxes for solar modules to which the invention relates in particular.

When threading on the cap nut the crush lamellas are pressed together with a conical taper corresponding to the diameter contraction of the sleeve component until the free ends of the crush lamellas contact one another. The distance of the crush lamellas from one another thus defines the maximum diameter reduction and therefore defines the minimum cable outer diameter that can be supported by the crush lamellas with pull relief.

Since a minimum quantity of crush lamellas is needed for reliably supporting the cable the distance of the particular crush lamellas from one another cannot be reduced at will. Therefore a minimum cable diameter is needed for secure support.

In so far there is a problem in the art in that devices of this type for fixating cables with pull relief only have a limited diameter tolerance as a function of the diameter of the sleeve component with respect to the cable to be supported. However, since for the typical use of the device in combination with junction boxes cables with very different diameters are being used, it is an object of the invention to improve the device known in the art so that it is configured for fixating cables with significantly different diameters.

### BRIEF SUMMARY OF THE INVENTION

The object is achieved by a device with device for fixating cables with pull relief, including a sleeve component with an outer thread in a first axial portion and a second axial portion that is formed by crush lamellas which are pressed against an outer circumferential surface of a cable that is being fixated, wherein the crush lamellas are pressed against the outer circumferential surface of the cable by a cap nut that is threaded onto the outer thread and provided with a cable pass through opening, wherein the sleeve component is provided with an insert on an inner circumference of its second axial portion that is formed by the crush lamellas, and wherein the insert reduces an inner diameter of the sleeve component, in particular with the characterizing features according to which the sleeve component is provided in the second axial portion of the sleeve component that is formed by the crush lamellas with an insert at inner circumference of the sleeve component that reduces the inner diameter of the sleeve component.

It is an advantage of the invention that the insert reduces the inner diameter of the sleeve component in the portion of the crush lamellas and adapts the inner diameter to a particular cable diameter that is smaller than the inner diameter of the sleeve component. By threading on the cap nut the crush lamellas are not pressed against the insert component. Thus, the insert component which has a certain amount of elasticity is pressed against the outer circumferential surface of the cable and retains the cable in the device through friction locking.

It is provide that the insert reducing the inner circumference includes a seal sleeve or is formed by a deal sleeve. A sleeve of this type not only advantageously adapts the inner circumference of the sleeve component to the cable to be supported, but simultaneously seals the device towards the outside. Consequently dust, contaminants and humidity cannot penetrate along the cable and through the device into an eventually closed junction box.

It is furthermore provided that the insert that reduces the inner circumference in turn also includes a support sleeve provided with crush lamellas. The advantage of a device configured in that manner is the crush lamellas of the insert have a higher tolerance with respect to different cable diameters. Furthermore the crush lamellas of the insert provide a safe fixation of the cable in the device. Contrary to the preceding embodiments an insert of this type is configured to support cables with various diameters. Thus it is provided that the crush lamellas of the sleeve component impact the crush lamellas of the support sleeve of the insert directly or indirectly.

A particular embodiment is characterized in that the insert reducing the inner circumference is formed by the seal sleeve and the support sleeve, wherein the seal sleeve arranges the support sleeve between itself and the second axial portion of the sleeve component. This embodiment combines the advantages of the insert with the support sleeve and the insert with seal sleeve.

It is furthermore provided that the second axial portion of the sleeve component configures a receiver for the insert on its inner circumference, in particular when the receiver secures the insert at least against an axial movement in insertion direction of a cable into the sleeve component.

Eventually it is provided that the sleeve component forms a portion of a junction box for solar modules.

### BRIEF DESCRIPTION OF THE DRAWINGS

The invention is subsequently described based on an embodiment with reference to drawing figures, wherein:

FIG. 1 illustrates an axial sectional view of a device according to the invention; and

FIG. 2 illustrates an exploded view of the device according to FIG. 1.

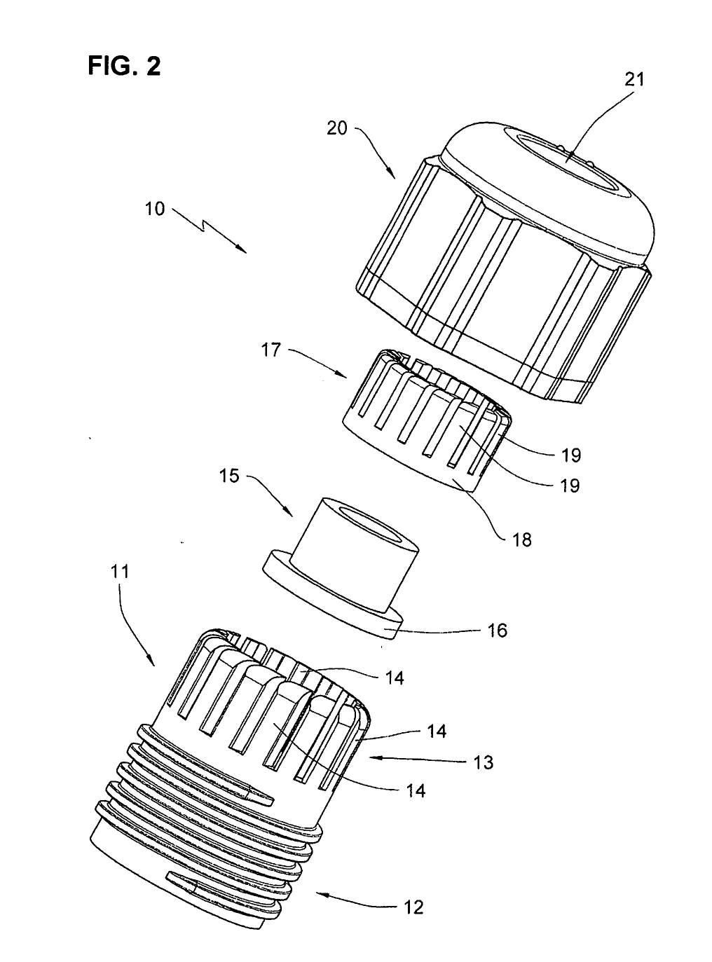

### DETAILED DESCRIPTION OF THE INVENTION

A device for fixating cables with pull relief is designated overall with the reference numeral 10. The device 10 includes a sleeve component which is designated overall with the reference numeral 11. The sleeve component 11 includes two axial portions or axial sections. The first axial section 12 is provided with an outer circumferential thread and can therefore be also designated as threaded section 12. The second axial section 13 is formed by the crush lamellas 14 and can therefore also be designated as lamella section 13. Typically the sleeve section 11 forms an integral one piece component with a junction box or an applied or integrally formed component of a junction box, in particular a junction box for solar modules.

The device 10 furthermore includes a seal sleeve 15 which is advantageously made from an elastic material. The inner diameter of the seal sleeve 15 is less than the inner diameter of the sleeve component 11. Furthermore the seal sleeve 15 is configured to be arranged in the sleeve component 11 so that it reduces the inner diameter of the sleeve component 11. The seal sleeve 15 includes a shoulder 16 on its outer circumference on which a support sleeve 17 is arranged. The support sleeve 17 is formed by a ring 18 which supports additional crush lamellas 19.

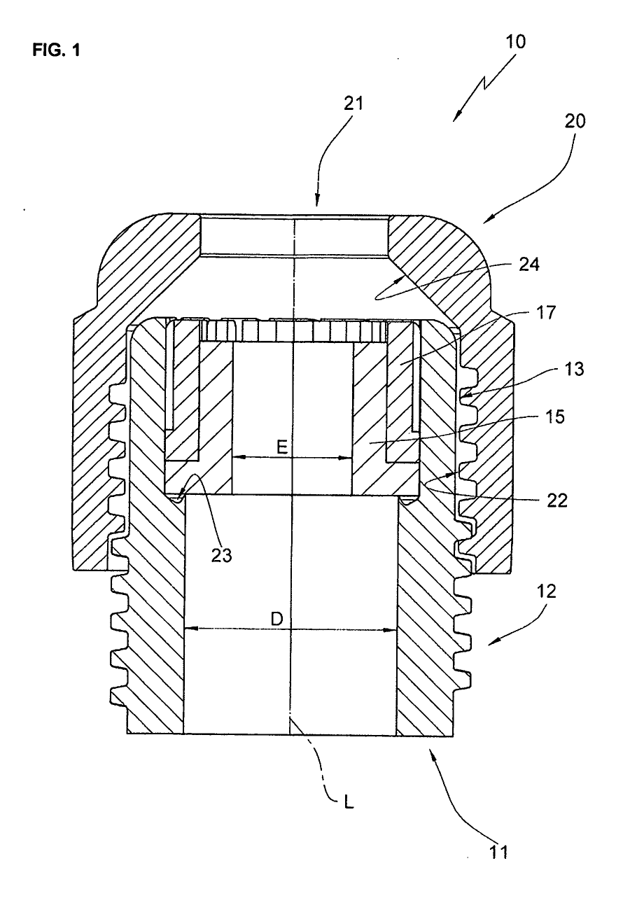

Eventually also a cap nut 20 is included in the device 10, wherein the cap nut includes a cable pass through opening 21 that is aligned with the sleeve cavities. The cap nut 20 is configured for threading onto the thread section 12 of the sleeve component 11 and includes an inner thread 22 for this purpose as can be derived from FIG. 1.

The axially cut representation of the device 10 in FIG. 1 initially illustrates that the sleeve component 11 includes an inner diameter D for cable pass through. The cable pass through opening 21 of the cap nut 20 has approximately the same inner diameter. The inner diameter E of the seal sleeve is reduced relative to the inner diameter D of the sleeve component.

It can be furthermore derived from FIG. 1 that the support sleeve 17 is supported between the seal sleeve 15 and the sleeve component 11. The seal sleeve 15 and the support sleeve 17 jointly form the insert according to the invention which reduces the diameter D. The lamella section 13 of the sleeve component 11 includes a receiver 23 on its inner circumference that is configured as a shoulder for an insert. The cap nut 20 tapers on its inner circumference between its section that is provided with an inner thread 22 and the pass through opening 21 and thus forms a crushing bevel 24.

When the insert including the seal sleeve 15 and the support sleeve 17 is not arranged in the receiver 23 the maximum cable diameter receivable by the sleeve component is defined by the inner diameter D. The smallest possible cable diameter which can still be supported by the crush lamellas 14 of the lamella section 13 is substantially defined through the maximum possible diameter reduction in the portion of the crush lamellas 14 through threading the cap nut 20 onto the threaded section 12 and eventually depends from the distance of the crush lamellas 14 from one another. As soon as the free ends of adjacent crush lamellas 14 contact one another there is not further diameter reduction in this portion.

When the device 10 shall support a cable with pull relief whose diameter is small enough so that the crush lamellas 14 of the sleeve component 11 cannot be pressed completely against its outer surface the insert including the seal sleeve 15 and the support sleeve 17 is inserted into the receiver 23 of the sleeve component. This initially reduces the maximum receivable cable diameter to the inner diameter E of the seal sleeve 15. The crush lamellas 14 of the lamellas section 13 of the sleeve component 11 are typically moved in a direction of a longitudinal central axis L of the device 10 in a known manner through contacting the crush bevel 24 of the cap nut 20 and in turn the crush lamellas 14 press the crush lamellas 19 of the support sleeve 17 together so that the diameter is reduced. The crush lamellas 19 are pressed against the outer surface of the cable to be supported. The minimum supportable cable diameter is now defined through the maximum diameter reduction of the crush lamellas 19 of the support sleeve 17. The maximum diameter reduction of the crush lamellas 19 in depends from the distance of the crush lamellas 19.

The diameter tolerance of the device 10 initially recited describes a band width of diameters in which the diameter of a cable which shall be fixated with pull relief has to be.

In the device 10 without the insert the diameter tolerance is only defined by the sleeve component 11. When the insert is supported in the sleeve component 11 the insert defines the diameter tolerance. Consequently the total diameter tolerance of the device 10 according to the invention is the sum of the diameter tolerance of the sleeve component 11 and the insert. Advantageously the diameter tolerance of the insert connects seamlessly with the diameter tolerance of the sleeve component. The device 10 according to the invention can be adapted to different cable diameters.

### REFERENCE NUMERALS AND DESIGNATIONS

10 device
11 sleeve component
12 first axial section/threaded section
13 second axial section/lamella section
14 crush lamellas
15 seal sleeve
16 step
17 support sleeve
18 ring
19 crush lamellas
20 cap nut
21 cable pass through opening
22 inner thread
23 receiver
24 crushing bevel
D inner diameter of 11
E inner diameter of 15
L longitudinal center axis

What is claimed is:

1. A device for fixating cables with pull relief, comprising:
a sleeve component including:
an outer thread in a first axial portion; and
a second axial portion that is formed by crush lamellas which are pressed against an outer circumferential surface of a cable that is being fixated,
wherein the crush lamellas are pressed against the outer circumferential surface of the cable by a cap nut that is threaded onto the outer thread and provided with a cable pass through opening;
wherein the sleeve component is provided with an insert on an inner circumference of its second axial portion that is formed by the crush lamellas, and
wherein the insert reduces an inner diameter of the sleeve component.

2. The device according the claim 1, wherein the insert includes a seal sleeve.

3. The device according to claim 2,
wherein the insert is formed by the seal sleeve and the support sleeve, and
wherein the seal sleeve arranges the support sleeve between itself and the second axial portion of the sleeve component.

4. The device according to claim 2, wherein the insert includes a support sleeve provided with crush lamellas.

5. The device according to claim 4,
wherein the insert is formed by the seal sleeve and the support sleeve, and
wherein the seal sleeve arranges the support sleeve between itself and the second axial portion of the sleeve component.

6. The device according to claim 1, wherein the insert includes a support sleeve provided with crush lamellas.

7. The device according to claim 6,
wherein the insert is formed by the seal sleeve and the support sleeve, and
wherein the seal sleeve arranges the support sleeve between itself and the second axial portion of the sleeve component.

8. The device according to claim 1, wherein the second axial portion of the sleeve component forms a receiver for the insert at an inner circumference of the second axial portion of the sleeve component.

9. The device according to claim 8, wherein a receiver secures the insert at least against an axial movement in an insertion direction of the cable into the sleeve component.

10. The device according to claim 1, wherein the sleeve component forms a portion of a junction box for solar modules.
